(19) United States
(12) Patent Application Publication
(10) Pub. No.: US 2008/0116016 A1
(43) Pub. Date: May 22, 2008

(54) Dumbwaiter System with Integrated LCD Display, Improved Mode Controls, and Complimentary Baskets and Carts

(76) Inventors: Andrew Darnley, III, El Dorado Hills, CA (US); Scott P. Allen, Placerville, CA (US); Thomas J. Darnley, Queensbury, NY (US)

Correspondence Address: WHITE-WELKER & WELKER, LLC, P.O. BOX 199, CLEAR SPRING, MD, 21722-0199, US

(21) Appl. No.: 11/562,418

(22) Filed: Nov. 22, 2006

(51) Int. Cl. B66B 1/34

(52) U.S. Cl. 187/391

(57) ABSTRACT

An improved dumbwaiter system that incorporates an LCD display which is connected to the system controller that provides installation and troubleshooting assistance in addition to standard operating information. The system teaches means for switching between manual and automatic modes within a standard operational configuration. The dumbwaiter of the present invention can switch into a manual mode by using the standard configuration, after the user enters a sequence of keys on a keypad, the LCD display will indicate the switch to manual mode and will confirm that appropriate safeties are in place prior to moving the car. The present invention also includes an interface to enable the dumbwaiter to operation in conjunction with other electronically controlled household amenities. The dumbwaiter is also supplied with a complimentary laundry basket and rolling cart. The baskets and carts are designed in such a manner to integrated with the cab of the dumbwaiter.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to residential dumbwaiters. More specifically, the present invention relates to residential dumbwaiters with integrated LCD displays, controls, and a variety of interchangeable baskets and carts.

### BACKGROUND OF THE INVENTION

The present invention is an improved dumbwaiter system comprised of several improvements making it novel and non-obvious over those currently known in the art. The present invention incorporates an LCD display that is connected to the system controller that provides installation and troubleshooting assistance in addition to standard operating information.

The present invention overcomes shortcomings in the prior art by providing means for switching between manual and automatic modes within a standard operational configuration. Currently, dumbwaiters run in an automatic mode by default, but manual mode is necessary for troubleshooting situations.

Dumbwaiter systems known in the prior art require special wire harness or temporary jumpers to by pass the automatic system to enable the dumbwaiter system to run in a manual mode. When using these temporary means, the user must bypass the safety features resulting in a hazardous or unsafe operating situation. The dumbwaiter of the present invention will switch into manual mode by using the standard configuration, after the user enters a sequence of keys on a keypad, the LCD display will indicate the switch to manual mode and will confirm that appropriate safeties are in place prior to moving the car.

In alternative embodiments of the present invention an interface will be incorporated to enable the dumbwaiter of the present invention to operation in conjunction with other electronically controlled household amenities.

In yet another embodiment of the present invention, the dumbwaiter will be supplied with a complimentary laundry basket and/or a rolling cart. The baskets and carts will be designed in such a manner to integrated with the cab of the dumbwaiter.

Other have attempted to develop dumbwaiter system, such as U.S. Patent Application 20030213652 entitled “Residential elevator” published on Nov. 20, 2003 to Long and assigned to Waupaca Elevator Company, Inc. that teaches a novel residential elevators, and novel methods of installing and using residential elevators. A residential elevator of the invention typically includes guide rail structure, a car, lift apparatus, and cables connecting the lift apparatus to the car. The guide rail structure is mounted to the building. The car is mounted to the guide rail structure.

U.S. Pat. No. 6,167,670 entitled “Casing system for dumbwaiters” issued to Reite, et al. on Jan. 2, 2001 teaches a system for building shaft casing for dumb-waiters in a building structure with prefabricated assemblies that are readily stackable over each other. One lower, middle and top assemblies constitute the minimum combination typically used in going from one floor to the next. However, the middle and upper assemblies can be repeated depending on the structure where the system is installed. The assemblies include each four elongated corner members with respective ends that receive connecting pin members that permit the structurally stable stacking up of the assemblies. A central and continuous passage is defined. The lower assembly includes two apertures with adjacent compartments within the central passage one to have access to the dumbwaiter and the other one to access the motor and control means. The top assembly has an aperture to provide access to the sprocket mechanism used with the chain that suspends the dumbwaiter within the shaft casing. The components in all assemblies are similar, contributing to the simplification of the inventory logistics.

U.S. Pat. No. 4,664,230 entitled “Elevator” issued to Olsen on May 12, 1987 teaches a convenience elevator that encompasses dumbwaiter and residential elevator applications wherein the entire elevator assembly is mounted to a wall of the elevator shaft. The elevator carriage is provided with sliding guides of high strength low friction polymer that slide in channels provided in vertical guide rails. A guideline fixes the relative position of the carriage and counter weight and a separate driveline controllably drives the carriage up and down in the shaft. Safety switches and brakes provide for efficient operation and the entire structure is designed for economical installation and operation.

U.S. Patent Application 20050077117 entitled “Elevator performance meter” published on Apr. 14, 2005 to Shrum, et al. and assigned to Waupaca Elevator Company, Inc. teaches an elevator performance meter is an embedded processor device specifically designed to measure the variations in velocity, acceleration, jerk and run duration as an elevator ascends and descends along a vertical axis. The performance meter utilizes an internal processor that is directly connected to a sensor via an analog to digital conversion unit, a program storage device, a display, a keypad, and power subsystems that are all contained within a single enclosure. The performance meter includes a display screen on its top surface with a keyboard for entering in operator menu selections. The performance meter is placed on the floor of an elevator and the embedded sensor measures certain physical properties of the elevator as it makes a floor-to-floor run. The measurement data is presented on the internal display as an alphanumeric readout that allows an elevator's performance to be easily defined.

U.S. Pat. No. 6,672,431 entitled “Method and system for controlling an elevator system” issued to Brand, et al. on Jan. 6, 2004 teaches a method controls an elevator system including multiple elevator cars and multiple floors. A new passenger at one of the floors signals a hall call. In response to receiving the hall call, the method determines, for each car, a set of all possible future states of the elevator system. The future states depend on the current state of the system, which is defined by passengers already assigned to cars, the direction of travel, position and velocity of the cars.

U.S. Pat. No. 6,341,668 entitled “Interactive elevator communication system” issued to Fayette, et al. on Jan. 29, 2002 teaches an elevator communication system that generally provides a computer device installed in an elevator cab. The computer device is configured with peripheral devices to display visual and audio information to cab riders.

U.S. Pat. No. 5,955,708 entitled “Control device for elevators” issued to Amano, et al. on Sep. 21, 1999 teaches that information is transmitted between respective control units to respond to a landing call made backward of other elevators in an elevator control apparatus with dispersed group management function, abolishing a group management device.

U.S. Pat. No. 5,844,181 entitled “Information display system” issued to Amo, et al. on Dec. 1, 1998 teaches a display apparatus within elevator cabs or elevator waiting areas that facilitates the simultaneous display of advertising and general news information is described.

U.S. Patent Application 20040154872 entitled “Elevator group supervisory control device” published on Aug. 12, 2004 to Hirade teaches an elevator group supervisory control system for an elevator system provided with indicators for a group supervisory control of a plurality of elevators, in which a car reversal, which becomes a cause of irritation for passengers, is curbed. For a hall call registered at an elevator hall which is ahead of a final car call and within a floor range defined bases on building or elevator conditions, an additional assignment is performed on an elevator whose predicted arrival time is the shortest, and which is not in charge of the elevator hall call.

U.S. Patent Application 20050098391 entitled “Passenger guidance system and display device” published on May 12, 2005 to Rintala, et al. teaches a passenger guidance system which comprises means for generating call data and means for transmitting call data to the group control systems of one or more elevator banks, said group control systems processing the call data to produce group call data and distributing the said group call data to the elevator control means of the elevator bank. The guidance system comprises a display device that is used to display the group call data for one or more group control systems.

U.S. Patent Application 20050056494 entitled “Information display system” published on Mar. 17, 2005 to Amo, et al. teaches a display apparatus within elevator cabs or elevator waiting areas that facilitates the simultaneous display of advertising and general news information is described.

### SUMMARY OF THE INVENTION

The present invention is an improved dumbwaiter system comprised of several improvements making it novel and non-obvious over those currently known in the art. The present invention incorporates an LCD display that is connected to the system controller that provides installation and troubleshooting assistance in addition to standard operating information.

The present invention overcomes shortcomings in the prior art by providing means for switching between manual and automatic modes within a standard operational configuration. Currently, all dumbwaiters run in an automatic mode by default, but manual mode is necessary for troubleshooting situations.

Currently, a special wire harness or temporary jumpers are need to by pass the automatic system to enable the dumbwaiter system to run in a manual mode. When using these temporary means, the user must bypass the safety features resulting in a hazardous or unsafe operating situation. The dumbwaiter of the present invention will switch into manual mode by using the standard configuration, after the user enters a sequence of keys on a keypad, the LCD display will indicate the switch to manual mode and will confirm that appropriate safeties are in place prior to moving the car.

In alternative embodiments of the present invention an interface will be incorporated to enable the dumbwaiter of the present invention to operation in conjunction with other electronically controlled household amenities.

In yet another embodiment of the present invention, the dumbwaiter will be supplied with a complimentary laundry basket and/or a rolling cart. The baskets and carts will be designed in such a manner to integrated with the cab of the dumbwaiter. It is assumed that this combination will provide patentable subject matter that can either be claimed alone or as dependant elements in one application for the base dumbwaiter system.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a line drawing of the hoistway and cab of the present invention;

FIG. 2 is a line drawing illustrating a side view of the hoistway as it extends over multiple floors and depicts a best mode for the positioning of the doors, electrical connections, and motor placement;

FIG. 3 is an image of the rail and its corresponding centerline, and roll pins;

FIG. 4 is an image of the pulley system, trolley, and rail of the present invention;

FIG. 5 is an image of the trolley, rail, and sensor placement of the present invention; and

FIG. 6 is an image of a sample control panel used by the present invention with an LCD screen.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is a dumbwaiter system with integrated LCD Display, improved mode controls, and complimentary baskets and a cart.

### Installation Process

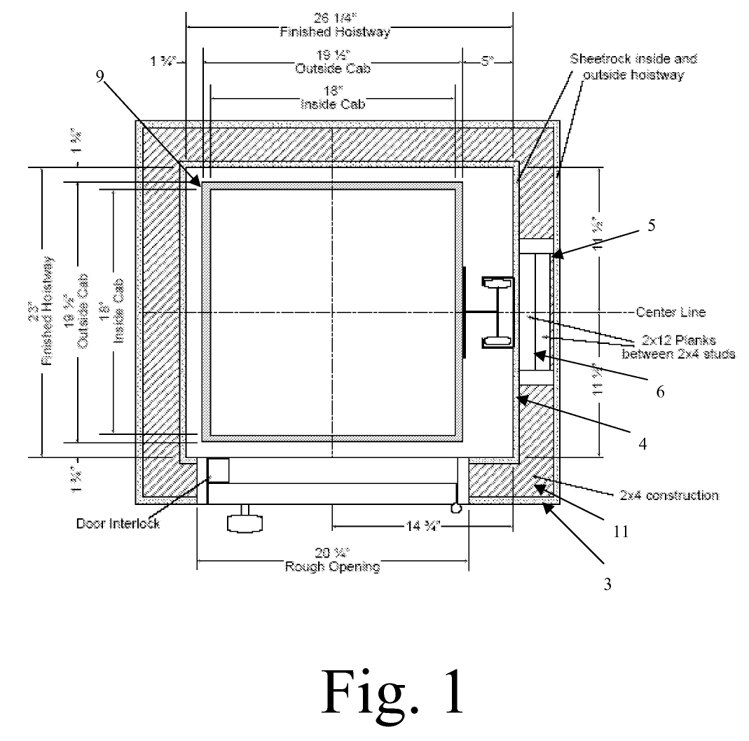

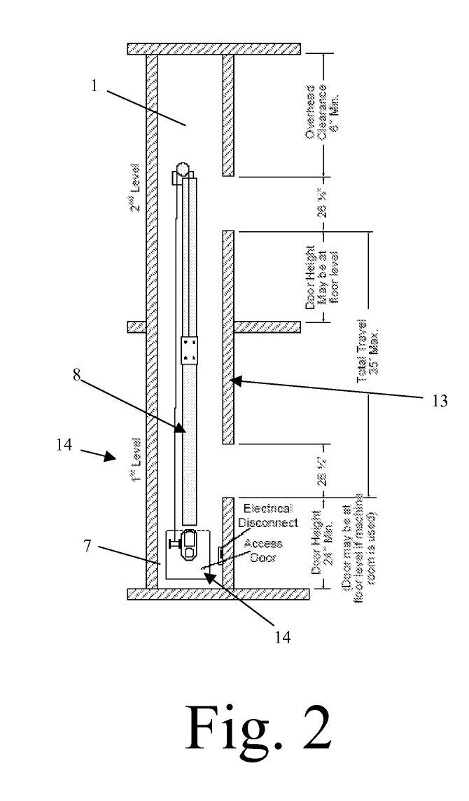

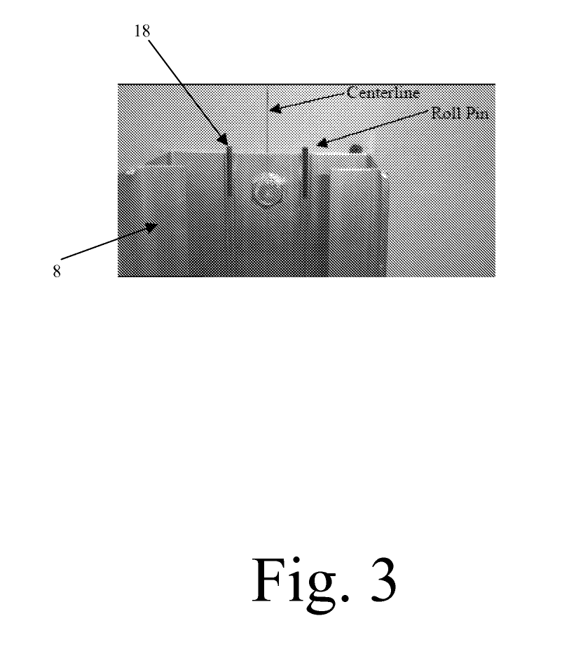

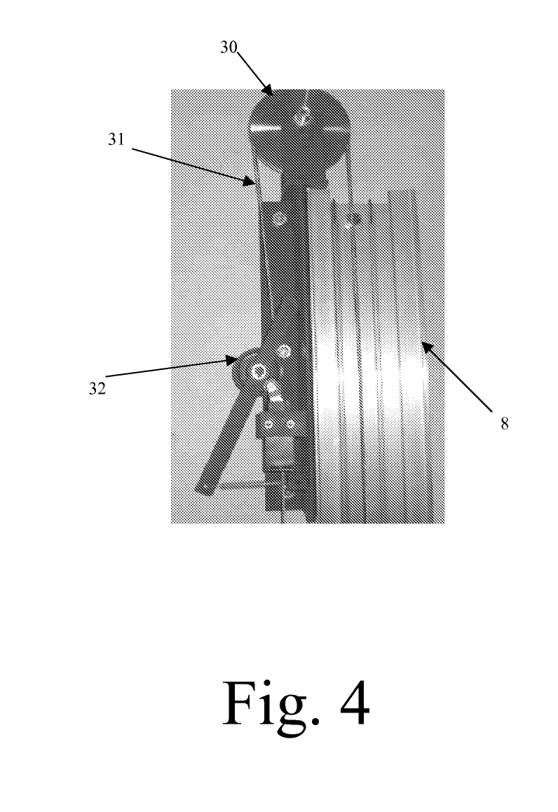

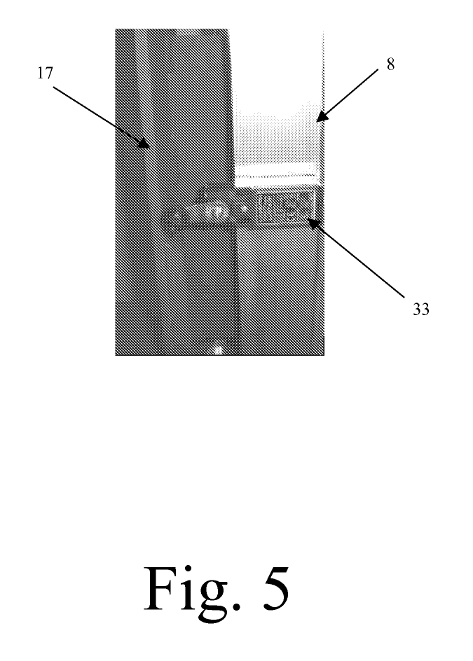

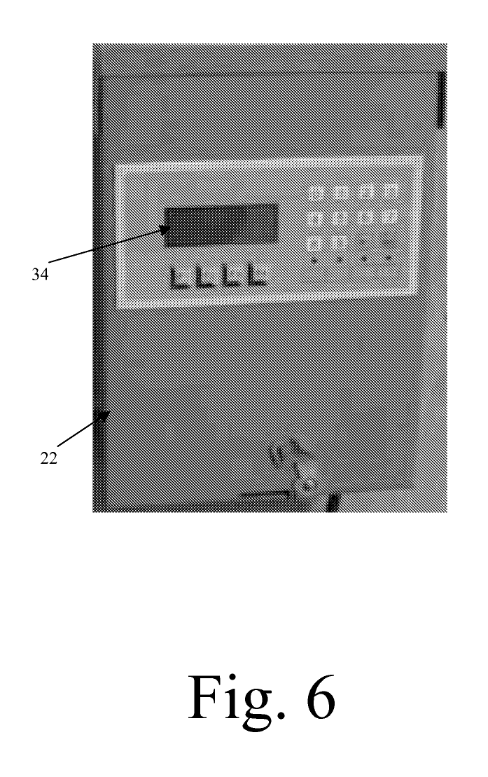

The installation procedure for the dumbwaiter of the present invention is disclosed as a step-by-step process and is illustrated in FIGS. 1-6. The installation of this dumbwaiter is easiest if the hoistway 1 is properly prepared as illustrated by the hoistway drawings of FIG. 1.

First the hoistway 1 must be built to exact dimensions as disclosed in FIG. 1 as the dimensions indicated in drawings are finished dimensions. After sheetrock 3 has been installed, it must be insured that hoistway walls 4 are built plumb and square. Next, the reinforced rail wall 5 must be built with 2 sets of 2×12 planks 6 as shown in FIG. 1. The motor assembly 7, rail 8, cab 9, and load 10 are all supported by this reinforced wall 5. The entire inside of the hoistway 4 must have sheetrock 3 installed prior to starting the installation. It is recommended to leave sheetrock 11 off the outside of hoistway wall 3 until installation is complete. This makes running of wire harnesses 12 much easier. Installation of the motor assembly 7 is much easier if one wall 13 on bottom level 14 is left unfinished. Once the rail 8 and motor assembly 7 are mounted, this wall 13 can be finished. A machine access door 14 should be installed on the lower level 14 for access to the motor assembly 7 and the controller 16 which must remain locked and closed during all operation periods. For safety during installation, the installer should install a temporary floor across the hoistway 1 at each of the upper levels. This will prevent people from falling down the dumbwaiter shaft during installation.

Installer should leave six inches of space from the reinforced wall 5 for the rail 8 to slide past the temporary floor and mark a centerline down the load-bearing wall. This is can be done with a chalk line, or a straight edge. Draw a mark twenty-four inches from the floor along the centerline to designate the bottom edge of the rail 8.

Hold the first trail against the wall with the bottom edge at the twenty-four inch mark. The centerline on the wall should be visible down the center of each hole in the rail. Mark the location of the bottom and top holes in the rail 8 and drill pilot holes using a drill bit. Insert roll pins in the slots at the top of the first piece of rail 8 and leave a quarter inch of roll pins protruding from the top of the rail 8. Next, mount the rail on the wall using lag bolts being cautious not to over tighten the lag bolts as this will bend the rail 8 and cause problems with trolley 17 movement. Confirm that the centerline is running down the center of the rail 8 and drill pilot holes and install lag bolts in remaining holes in the rail 8. The first rail 8 should be mounted such that the centerline on the wall lines up with the centerline of the rail 8. The roll pins 18 should be protruding out of the rail 8.

A second rail should be placed in position above the first rail 8. The roll pins 18 should slide in the slots 20 on the second rail, insuring that there is no space between the rails. Pilot holes are drilled to secure the second rail in place using lag bolts provided and this process is repeated with any remaining rails, taking care to keep rails lined up with the centerline.

Now the trolley 17 is installed from the bottom of the rail 8. Lifting on the quicklink will release the brake system, allowing the trolley 17 to move freely. Lift the trolley to a height of 30″ above the floor. The brake will engage when the quicklink is released, locking the trolley 17 in that location.

Next the motor assembly 20 is positioned against the wall 21 below the rail and two small 2×4 blocks are placed under the motor 20 to lift it from the floor. These will be used as temporary spacers. The centerline is lined up on the wall with the centerline on the motor assembly 20. Using a level to insure the drum is perfectly horizontal the locations of mounting holes on the motor assembly 20 are lined up. Pilot holes are drilled to secure the motor assembly 20 to the wall using lag bolts and the blocks are removed from under the motor 20.

The pulley assembly 30 is set at the top of the rail 8. This will stay in place at the top of the rail 8 while pilot holes are marked and drilled to secure the pulley assembly 30 in place with lag bolts. The stainless steel cable 31 is attached to the winding drum by wrapping the cable around the winding drum, staying in the machined grooves. The cable is feed to the right of the small pulley 32 and over the top of the large pulley 30 and down the center of the rail towards the trolley 17, taking all slack out of the cable.

The cable must be attached to the trolley quicklink using cable clamps. The cable clamps must be arranged such that the curve of the ‘U’ is wrapping around the cut end of the cable. Excess cable can be cut or folded and zip-tied as shown. Weight is added to the trolley 17 equivalent to the cab or mount the cab to adjust the slack cable switch on the assembly.

Limit switches 33 are used to sense the location of the dumbwaiter cab and stop it at the appropriate level. The first level limit switch is located on the harness closest to a pin connector. The first limit switch is mounted on the rail 8 approximately one inch above the bottom level of the first door opening such that the holes line up with the groove 21 along the side of the rail 8.

The remaining switches are mounted, one for each level. There will be one extra switch that should be mounted six inches above the upper level switch. This last switch is called the Upper Final limit switch. Above the Upper Final limit switch is a length of wire with a four-pin connector on the end. This wire is run over the top of the rail and attached to the Slack Cable limit switch. The Slack Cable limit switch is on the lower part of the pulley assembly 31.

The controller 22 is mounted in a location that will be convenient for viewing the text display on the LCD screen 34. The controller 22 is positioned such that cable harnesses can be run to the connectors mounted on sides and top of the controller 22, and the power cord can reach a power source. A recommended location for the controller 22 is the back of the machine access door 14. The Limit Switch harness is connected to the cable labeled “limit switches” using bullet connectors.

The ‘0’ key controls up direction and ‘8’ key for down direction to move the trolley to each level. Confirmation that the limit switches are engaging when the trolley is at each level. The Final Limit switch should engage when the trolley travels beyond the upper level. The limit switch locations should be adjusted such that each limit switch is centered on the trolley's cam, the steel piece that hits limit switches, when the trolley is level with each door.

Once the limit switch locations are confirmed, the limit switches must be permanently mounted. The mounting points should fall in the groove near the side of the rail. Using a thread tapping screw cut threads in the holes.

Position the trolley 17 at the first level. Slide the dumbwaiter cab through the first level door rough opening and rest the cab on the trolley's steel support. The bottom of the cab is secured using ⅜ carriage bolts. The controller is placed in Manual Mode: Pressing and holding the F5 key for 20 seconds until the display shows. Using the up and down arrows on the controller to slowly move the dumbwaiter cab 17 through the hoistway 1, insuring with each increment that there are no clearance issues with hoistway walls, wire harnesses, or other obstructions. If the cab isn't square with the hoistway 1 along the length of the hoistway 1, shims may be needed between the cab and the trolley. If the cab moves out of square in different regions of the hoistway 1, then shims may be needed between the rail and the wall at the locations where the cab is not square. If cab hits an obstruction in the down direction, and cable will have slack and the trolley brake will be engaged. To disengage the brake on the trolley 17, raise the cab upward. Verify the cable is in the proper position on the winding drum and not overlapping itself. Press the ‘Enter’ key on the controller 22 to exit Manual Mode.

Install the doors at each level. The interlocks are mounted in the upper corner of the door jam, on the side opposite the hinges. The interlock ‘keeper’ is mounted on the inside of the door such that it latches with the interlock when the door is closed.

The call stations are labeled according to the level. The interlocks have a cable with four connectors that attaches to a cable hanging from the call station. Run the wire through the wall to the call station. The connections should be made by matching the colors on each cable. Run the harness from the call station through the hoistway wall to the location where the controller 22 will be mounted. If the harness is not run though the wall, behind the sheetrock, then the harness must be attached firmly to the wall such that the moving cab, trolley 17, and cable will not touch the harness. Connect the call station harnesses to the cables hanging from the controller 22, carefully matching the colored wires. The connectors are labeled according to their level.

With installation complete, the dumbwaiter is now ready for Automatic Operation. Close the doors at every level. View the controller display 23 to determine if all safeties are in place. If the display shows “Automatic Mode” then the safeties are set and one can start operating the dumbwaiter. If there are any errors, then one must troubleshoot.

Normal Operation-All button lights are off-Controller display reads “Automatic Mode”-Press the call button for level ‘x’-Dumbwaiter cab moves to level ‘x’ and stops-Button light for level ‘x’ is lit solid during movement-Button light for level ‘x’ blinks fast while interlock is unlocked-Door interlock stayed unlocked for 10 seconds-Once door is closed again, the cab can be called to another level-If cab is already at level ‘x’, pressing the level ‘x’ button unlocks the interlock-Calls to other floors are not recognized when dumbwaiter is moving-Calls to other floors are not recognized when door is unlocked.

When running in automatic mode with the cab completely assembled, one may find the need to adjust the limit switch levels. Test the leveling of the cab at each level, calling from up direction and down direction. Do this several times to determine if a limit switch is too high or low. If the level must be adjusted, take a measurement to determine the distance that the limit switch must be moved.

Set the controller in Manual Mode and use the ‘0’ and ‘8’ keys to move the cab out of the doorway, leaving access to the limit switch to be moved. Press the F1 button on the controller to unlock the 1st floor door (F2 for 2nd floor door, etc). Draw a line under and over the limit switch to designate the original location. Remove the limit switch and re-attach at the measured offset.

In an alternative embodiment, larger cabs may require a Stabilizer Bracket. After the cab is mounted to the trolley 17 and supporting it's own weight the bracket should be twisted into place.

The present invention is the first Dumbwaiter with an LCD display. This display is integrated in the controller 22 and provides installation assistance, troubleshooting assistance, and general operating information.

The LCD display indicates error messages such as ‘Level X Door Ajar’, ‘Slack Cable Error’, ‘Final Limit Error’, ‘Please Close Gate’ ‘Car at Level X’, ‘Car Traveling Up to Level X’, ‘Car Traveling Down to Level X’.

This present invention is also the first Dumbwaiter that provides for switching between manual and automatic modes within standard configuration. All dumbwaiters run in automatic mode by default. Manual mode is necessary for troubleshooting scenarios. A special wire harness or temporary jumpers are needed for most dumbwaiters to run in manual mode. When using these temporary means, the user is bypassing safeties and creating possible hazardous situations. This new dumbwaiter will switch into manual mode by using the standard configuration. The user will enter a key sequence on a keypad and the LCD display will indicate the switch to manual mode. The controller will confirm that appropriate safeties are in place prior to moving the car.

The present invention also teaches a custom rail 8 that makes assembly and mounting of rail much easier than the system taught in the prior art. The custom rail also allows for easy mounting of limit switches as previously discussed.

Home automation is very popular method of controlling lights and appliances. The present invention is the first dumbwaiter to interface with X-10 so that when one opens the garage door, the dumbwaiter is automatically sent to the garage level, ready to receive ones groceries.

The use of Ethernet cables keeps wiring as simple as possible. The present invention utilizes RJ-45 (Ethernet) connectors whenever possible making wiring easy, and replacement/extension of wires easy.

In an alternative embodiment, many customers will use the dumbwaiter for laundry. They often search for the closest fit laundry basket. A matching dumbwaiter car and laundry basket for ease of use, and maximizing space can be used in combination with the dumbwaiter system.

In yet another embodiment, many customers will position the dumbwaiter door at floor level and use a cart to roll items in/out and a specialized matching dumbwaiter car and cart can be used in combination with the dumbwaiter system.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A dumbwaiter device consisting of:
a hoistway extending for one or more floors of a residence having a door at each floor;
said hoistway built to exact dimensions plumb and square;
said hoistway defined as an interior of four walls with sheetrock installed on the interior and exterior portions of each of said four walls;
said hoistway further comprised of a reinforced rail wall
a motor assembly;
a rail;
said rail further consisting of slots for securing roll pins;
said roll pins secured at the top of a first rail, protruding from the top of the first rail;
a second rail placed above the first rail secured to said first rail by engaging the protruding rolls pins of the first rail; and
a cab;
a controller with buttons and an LCD display
a load supported by said reinforced wall;
a machine access door installed on a lower level providing access to the motor assemble;
a trolley;
a quicklink to release a brake system,
a pulley assembly consisting of a small and large pulley set at the top of the rail;
a stainless steel cable attached to a winding drum by wrapping the cable around the winding drum, staying in machined grooves;
said cable feed to the right of the small pulley over the top of the large pulley and down the center of the rail towards the trolley and attached to the trolley quicklink.

2. The dumbwaiter device of claim 1 wherein the process of placing a second rail above a first rail secured to said first rail by engaging the protruding rolls pins of the first rail is repeated with a plurality of remaining rails until the desired rail length is achieved.

3. The dumbwaiter device of claim 1 further comprising limit switches to sense the location of the dumbwaiter cab and stop it at the appropriate level wherein a first level limit switch is mounted on the rail at the bottom level of the first door opening.

4. The dumbwaiter device of claim 3 consisting of wherein limit switches are mounted, one for each level and an upper final limit switch mounted above the uppermost limit switch so that the final limit switch is engage when the trolley travels beyond the upper level.

5. The dumbwaiter device of claim 1 wherein
a controller is mounted in a location that will be convenient for viewing the text display on the LCD screen;
said controller is positioned such that cable harnesses can be run to the connectors mounted on sides and top of the controller, and the power cord can reach a power source; and
a limit switch harness on the controller provides connections to the limit switches.

6. The dumbwaiter device of claim 5 wherein the controller is located on the back of the machine access door.

7. The dumbwaiter device of claim 5 wherein the limit switch harness on the controller provides connections to the limit switches using bullet connectors.

8. The dumbwaiter device of claim 5 wherein the controller controls the down and up directions to move the trolley to each level such that adjustments are made so that each limit switch is centered on the trolley's cam when the trolley is level with each door.

9. The dumbwaiter device of claim 1 wherein doors at each level consist of interlocks which are mounted in the upper corner of the door jam, on the side opposite the hinges and an interlock keeper is mounted on the inside of the door such that it latches with the interlock when the door is closed.

10. The dumbwaiter device of claim 1 wherein the controller can operate in an automatic or manual mode.

11. The dumbwaiter device of claim 10 wherein with the controller in Automatic mode
in normal operation all button lights are off and the controller display reads “Automatic Mode”
when the call button is pressed for a selected level the cab moves to the selected level and stops, the button light for the selected level is lit solid during movement;
the button light for the selected level blinks fast while interlock is unlocked;
door interlock stays unlocked for 10 seconds;
once door is closed again, the cab can be called to another level and if the cab is already at the selected level, pressing the selected level button unlocks the interlock;
calls to other floors are not recognized when the dumbwaiter is moving; and
calls to other floors are not recognized when door is unlocked.

12. The dumbwaiter device of claim 1 further consisting of a stabilizer bracket.

13. The dumbwaiter device of claim 1 wherein the LCD display is integrated in the controller and provides installation assistance, troubleshooting assistance, and operating information.

14. The dumbwaiter device of claim 13 wherein the LCD display indicates error messages.

15. The dumbwaiter device of claim 10 wherein the controller provides for switching between a manual mode for troubleshooting and automatic modes for operation within a standard configuration.

16. The dumbwaiter device of claim 15 wherein entering a key sequence on a keypad connected to the controller and the LCD display will indicate the switch to manual mode and the controller will confirm that appropriate safeties are in place prior to moving the cab.

17. The dumbwaiter device of claim 10 further comprising an X-10 interface enabling home automation.

18. The dumbwaiter device of claim 17 providing Ethernet cables for motor, controller, and interface controls.

19. The dumbwaiter device of claim 1 further comprising a matching dumbwaiter car and laundry basket for ease of use, and maximizing space can be used in combination with the cab.

20. The dumbwaiter device of claim 1 further comprising a matching dumbwaiter car and cart to roll items in and out of the cab.
